(19) United States
(12) Patent Application Publication
(10) Pub. No.: US 2025/0303748 A1
(43) Pub. Date: Oct. 2, 2025

(54) PRINTING APPARATUS, CONTROL METHOD OF PRINTING APPARATUS, AND MEDIUM

(71) Applicant: BROTHER KOGYO KABUSHIKI KAISHA, Nagoya (JP)

(72) Inventor: SHOTA MORIKAWA, Nagoya (JP)

(21) Appl. No.: 19/082,880

(22) Filed: Mar. 18, 2025

(30) Foreign Application Priority Data
Mar. 27, 2024 (JP) 2024-051942

(51) Int. Cl. B41J 2/51; B41J 2/21; B41J 11/00; B41J 11/62; G06K 15/02; G06K 15/10

(52) U.S. Cl. CPC B41J 2/51; B41J 2/2132; B41J 11/008; B41J 11/62; G06K 15/102; G06K 15/186

(57) ABSTRACT

A printing apparatus including a head; a conveyor; and a controller. The controller is configured to execute: a first obtaining process of obtaining information on drying risk of an ink; and a printing process. A partial image includes an overlap image and a non-overlap image. The controller is configured to execute a second obtaining process of obtaining, based on the information on the drying risk, a first or second mask pattern as a mask pattern of a mask to be applied to image data of the overlap image. A number of a mask part of the second mask pattern with respect to an end part, of the overlap image, located away from the non-overlap image is smaller than a number of the mask part of the first mask pattern with respect to the end part.

### REFERENCE TO RELATED APPLICATIONS

This application claims priority from Japanese Patent Application No. 2024-051942 filed on Mar. 27, 2024. The entire content of the priority application is incorporated herein by reference.

### BACKGROUND ART

As a conventional printing apparatus, for example, a printing apparatus including a first nozzle which ejects an ink of a basic color and a second nozzle which ejects an ink of a special color different from the basic color is known.

### SUMMARY

In the above-described printing apparatus, the ink of the basic color is ejected from the first nozzle and the ink of the special color is ejected from the second nozzle so as to print an image. However, since some images do not frequently use the ink of the special color, the ejection frequency of the ink of the special color might be lower than the ejection frequency of the ink of the basic color, in some cases. In such a case, since the ink of the special color in the second nozzle dries more easily than the ink of the basic color in the first nozzle, there is such a problem that unsatisfactory ejection of the ink from the second nozzle is likely to occur.

In view of the foregoing situation, the present disclosure aims to provide a printing apparatus, a control method of a printing apparatus, and a medium each of which can suppress an unsatisfactory ejection of an ink.

According to a first aspect of the present disclosure, there is provided. a printing apparatus including:
a head having a plurality of nozzles;
a conveyor configured to convey a print medium in a conveying direction; and
a controller, wherein:
the controller is configured to execute:
a first obtaining process of obtaining information on drying risk of an ink in the plurality of nozzles; and
a printing process of performing an ejecting operation of ejecting the ink from the plurality of nozzles to the print medium based on image data of a partial image being a part of a print image, and a conveying operation of conveying the print medium;
the partial image includes:
an overlap image being an area to be overlapped with another partial image adjacent to the partial image; and
a non-overlap image being an area different from the overlap image and not to be overlapped with the another partial image;
the controller is configured to, in the printing process, overlap the overlap image of the partial image as an object of the ejecting operation performed currently with the overlap image of the partial image as an object of the ejecting operation performed last time;
the controller is further configured to execute a second obtaining process of obtaining, based on the information on the drying risk, a first mask pattern or a second mask pattern as a mask pattern of a mask to be applied to image data of the overlap image, the mask pattern including a mask part configured to cause the ink not to be ejected from a nozzle, of the plurality of nozzles, corresponding to the overlap image in the ejecting operation; and
a number of the mask part of the second mask pattern with respect to an end part, of the overlap image, located away from the non-overlap image in the conveying direction is smaller than a number of the mask part of the first mask pattern with respect to the end part, of the overlap image, located away from the non-overlap image in the conveying direction.

According to a second aspect of the present disclosure, there is provided a control method of a printing apparatus, the printing apparatus including:
a head having a plurality of nozzles; and
a conveyor configured to convey a print medium in a conveying direction,
the control method including causing the printing apparatus to execute:
a first obtaining process of obtaining information on drying risk of an ink in the plurality of nozzles; and
a printing process of performing an ejecting operation of ejecting the ink from the plurality of nozzles to the print medium based on image data of a partial image being a part of a print image, and a conveying operation of conveying the print medium, wherein:
the partial image includes:
an overlap image being an area to be overlapped with another partial image adjacent to the partial image; and
a non-overlap image being an area different from the overlap image and not to be overlapped with the another partial image; and
in the printing process, the overlap image of the partial image as an object of the ejecting operation performed currently is overlapped with the overlap image of the partial image as an object of the ejecting operation performed last time,
the control method further including causing the printing apparatus to execute a second obtaining process of obtaining, based on the information on the drying risk, a first mask pattern or a second mask pattern as a mask pattern of a mask to be applied to image data of the overlap image, the mask pattern including a mask part configured to cause the ink not to be ejected from a nozzle, of the plurality of nozzles, corresponding to the overlap image in the ejecting operation,
wherein a number of the mask part of the second mask pattern with respect to an end part, of the overlap image, located away from the non-overlap image in the conveying direction is smaller than a number of the mask part of the first mask pattern with respect to the end part, of the overlap image, located away from the non-overlap image in the conveying direction.

According to a third aspect of the present disclosure, there is provided a non-transitory and computer-readable medium storing a program executable by a controller of a printing apparatus, the printing apparatus including:
a head having a plurality of nozzles;
a conveyor configured to convey a print medium in a conveying direction; and the controller,
the program is configured to cause the controller to execute:
a first obtaining process of obtaining information on drying risk of an ink in the plurality of nozzles; and
a printing process of performing an ejecting operation of ejecting the ink from the plurality of nozzles to the print medium based on image data of a partial image being a part of a print image, and a conveying operation of conveying the print medium, wherein:
the partial image includes:
an overlap image being an area to be overlapped with another partial image adjacent to the partial image; and
a non-overlap image being an area different from the overlap image and not to be overlapped with the another partial image; and
in the printing process, the overlap image of the partial image as an object of the ejecting operation performed currently is overlapped with the overlap image of the partial image as an object of the ejecting operation performed last time,
the program is further configured to cause controller to execute a second obtaining process of obtaining, based on the information on the drying risk, a first mask or a second mask as a mask pattern of a mask to be applied to image data of the overlap image, the mask pattern including a mask part configured to cause the ink not to be ejected from a nozzle, of the plurality of nozzles, corresponding to the overlap image in the ejecting operation,
wherein a number of the mask part of the second mask pattern with respect to an end part, of the overlap image, located away from the non-overlap image in the conveying direction is smaller than a number of the mask part of the first mask pattern with respect to the end part, of the overlap image, located away from the non-overlap image in the conveying direction.

According to the present disclosure, in the printing process, the overlap image of the partial image as the object of the ejecting operation performed currently overlaps with the overlap image of the partial image as the object of the ejecting operation performed last time. The mask causing the ink not to be ejected from a part of the nozzles in the ejecting process is applied to the image data of the overlap images. By doing so, in a case where the ejection frequency of the ink from the nozzles is reduced, the risk that the ink dries in the nozzles is likely to increase. With respect to this, by using the mask of a mask pattern having the smaller number of the mask part in the ejecting operation, based on information on the drying risk, the ejection frequency of the ink can be increased and the unsatisfactory ejection of ink can be reduced.

The above-described object, other objects, the feature and the advantageous effect of the present disclosure will become apparent from the following detailed description of an embodiment of the present disclosure, with reference to the accompanying drawings.

### BRIEF DESCRIPTION OF DRAWINGS

FIG. 1 is a schematic view of a printing apparatus according to the present disclosure, as seen from above.

FIG. 2 is a functional block diagram depicting the configuration of the printing apparatus of FIG. 1.

FIG. 3 is a schematic diagram depicting a head of FIG. 1, as seen from below.

FIG. 4 is a view depicting a partial image, an overlap image, and a non-overlap image.

FIG. 5A is a diagram depicting a mask of a first mask pattern and a kth partial image. FIG. 5B is a diagram depicting the mask of the first mask pattern and a (k+1)th partial image.

FIG. 6A is a diagram depicting a mask of a second mask pattern X and the kth partial image. FIG. 6B is a diagram depicting the mask of the second mask pattern X and the (k+1)th partial image.

FIG. 7A is a diagram depicting a mask of a second mask pattern Y and the kth partial image. FIG. 7B is a diagram depicting the mask of the second mask pattern Y and the (k+1)th partial image.

FIG. 8A is a graph depicting a ratio of a mask part of the first mask pattern with respect to each of a kth overlap area on the upstream and a (k+1)th overlap area on the downstream which overlap with each other. FIG. 8B is a graph depicting a ratio of a mask part of the second mask pattern X with respect to the kth overlap area on the upstream and the (k+1)th overlap area on the downstream which overlap with each other. FIG. 8C is a graph depicting a ratio of a mask part of the second mask pattern Y with respect to each of the kth overlap area on the upstream and the (k+1)th overlap area on the downstream which overlap with each other.

FIG. 9 is a flow chart depicting an example of a control method of the printing apparatus.

FIG. 10 is a flowchart depicting an example of a mask process.

FIG. 11A is a diagram depicting a mask of a second mask pattern X and a kth partial image of the printing apparatus, and FIG. 11B is a diagram depicting a mask of the second mask pattern X of FIG. 11A and a (k+1)th partial image.

FIG. 12A is a diagram depicting a mask of a second mask pattern Y and the kth partial image of the printing apparatus, and FIG. 12B is a diagram depicting the mask of the second mask pattern Y of FIG. 12A and the (k+1)th partial image.

FIG. 13 is a flow chart depicting an example of the mask process in a control method of the printing apparatus.

### DESCRIPTION

### Configuration of Printing Apparatus

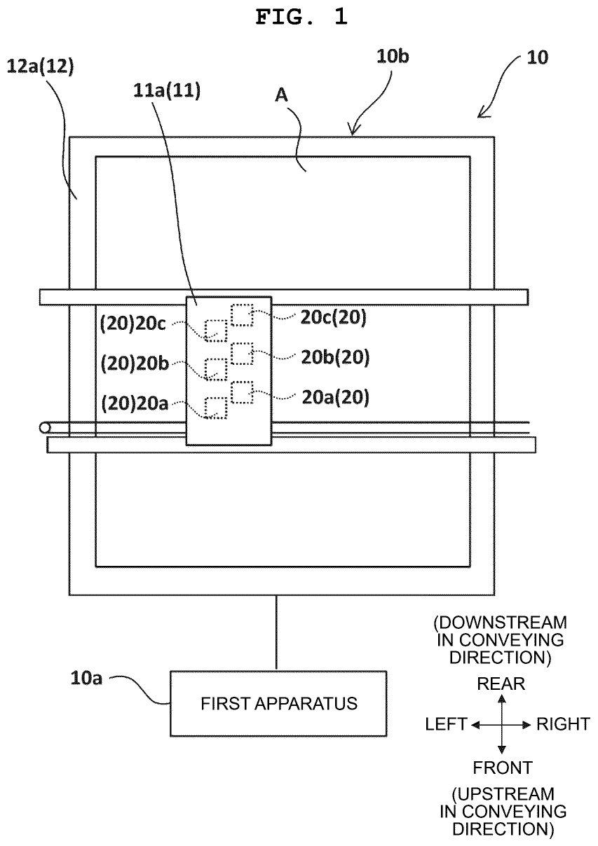

A printing apparatus 10 according to an embodiment of the present disclosure is an apparatus configured to print an image on a print medium A by a head 20, as depicted in FIG. 1. The print medium A is, for example, a sheet of paper, cloth, etc.

In the following, a moving direction in which the head 20 moves is referred to as the left-right direction. A direction which crosses (e.g., is orthogonal to) the moving direction and in which the print medium A is conveyed is referred to as the front-rear direction. A direction which crosses (e.g., is orthogonal to) the moving direction of the head 20 and the conveying direction of the print medium A is referred to as the up-down direction. However, the directions related to the printing apparatus 10 are not limited to these directions.

Further, the printing apparatus 10 includes a first apparatus 10a and a second apparatus 10b which can communicate with each other. The first apparatus 10a is an apparatus which processes image data, such as for example a personal computer, etc. The second apparatus 10b is an apparatus which prints an image on the print medium A based on the image data processed by the first apparatus 10a, such as for example an ink-jet printer of the serial head system.

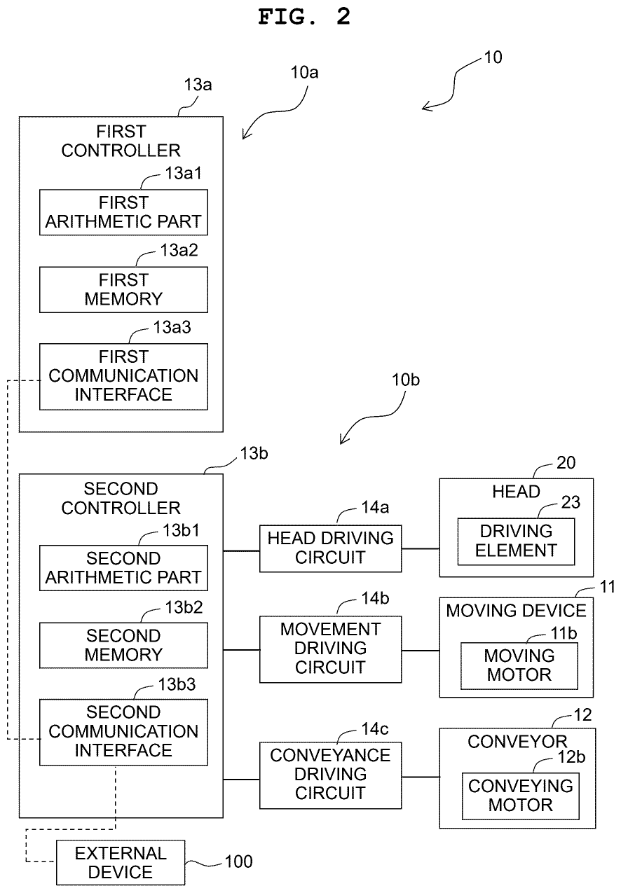

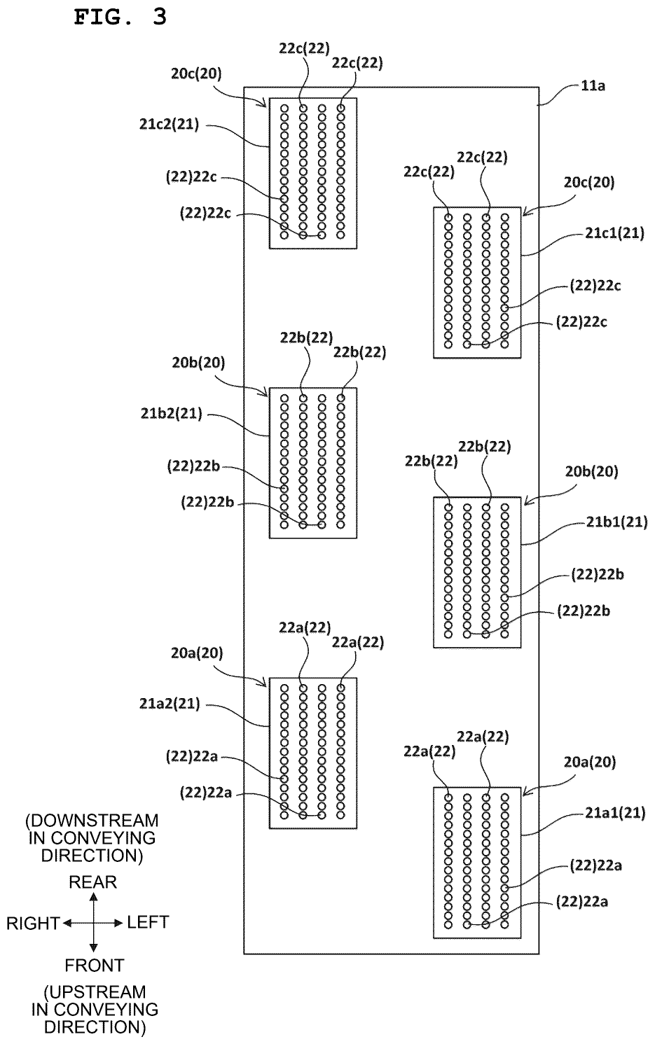

The second apparatus 10b includes a plurality of heads 20. Each of the plurality of heads 20 includes a chip 21 (FIG. 3), a plurality of nozzles 22 (FIG. 3), and a plurality of driving elements 23 (FIG. 2). The plurality of nozzles 22 is open in the lower surface of the chip 21. Each of the plurality of driving elements 23 is a piezoelectric element, a heating element, an electrostatic actuator, etc., and is disposed with respect to a nozzle 22 included in the plurality of nozzles 22 and corresponding thereto. The driving element 23 applies the pressure, by which the ink is ejected from the nozzle 22, to the ink in the head 20, causing the ink to be ejected from the nozzle 22 to the print medium A. The details of each of the plurality of heads 20 will be described later.

The second apparatus 10b further includes a moving device 11 which causes the plurality of heads 20 to move in the left-right direction. The moving device 11 includes a carriage 11a and a moving motor 11b (FIG. 2). The carriage 11a has a shape of a box, has the plurality of heads 20 mounted thereon, and is connected to the moving motor 11b. Therefore, in a case where the moving motor 11b is driven to rotate, the moving device 11 causes the carriage 11a and the plurality of heads 20 to move in the left-right direction.

The second apparatus 10b further includes a conveyor 12 which conveys the print medium A in the front-rear direction. The conveyor 12 has, for example, a platen 12a and a conveying motor 12b (FIG. 2). The platen 12a is located below the plurality of heads 20 at a predetermined distance. A flat upper surface of the platen 12a is disposed to face the lower surface of the chip 21 and supports the print medium A from below. The conveying motor 12b is connected to the platen 12a. In a case where the conveying motor 12b is driven to rotate, the conveyor 12 conveys the platen 12a and the print medium A in the front-rear direction.

As depicted in FIG. 2, the second apparatus 10b further includes a second controller 13b, and a head driving circuit 14a, a movement driving circuit 14b, and a conveyance driving circuit 14c electrically connected to the second controller 13b. The second controller 13b is constructed, for example, of a computer, and includes a second arithmetic part 13b1, a second memory 13b2, and a second communication interface 13b3.

The second communication interface 13b3 is a connecting device which is connected to an external device 100 which exists independently of the printing apparatus 10. The second memory 13b2 is a memory accessible from the second arithmetic part 13b1, and has, for example, a RAM, a ROM, etc. The second memory 13b2 stores data inputted from the second communication interface 13b3, as well as a program and various data used in a data process by the second arithmetic part 13b1.

The second arithmetic part 13b1 includes a circuit such as a processor such as a CPU, an integrated circuit such as an ASIC, or both. The second arithmetic part 13b1 executes the program while referring to the data stored in the second memory 13b2, and the second controller 13b thereby controls the operations of the respective parts of the second apparatus 10b. By doing so, the second apparatus 10b executes various processes such as a pass dividing process, a mask process, a printing process, etc.

The second controller 13b is electrically connected to the driving element 23 of the head 20 via the head driving circuit 14a, and controls the driving of the driving element 23 based on image data of a print image B. Further, the second controller 13b is electrically connected to the moving motor 11b of the moving device 11 via the movement driving circuit 14b, and controls the driving of the moving motor 11b. Furthermore, the second controller 13b is electrically connected to the conveying motor 12b of the conveyor 12 via the conveyance driving circuit 14c, and controls the driving of the conveying motor 12b.

Further, the first apparatus 10a includes a first controller 13a. The first controller 13a is constructed, for example, of a computer, and includes a first arithmetic part 13a1, a first memory 13a2, and a first communication interface 13a3. The first memory 13a2 is a memory accessible from the first arithmetic part 13a1, and includes at least one of, for example, a RAM and a ROM, and stores data inputted from the first communication interface 13a3, as well as a program and various data used in a data process by the first arithmetic part 13a1.

The first arithmetic part 13a1 includes a processor such as a CPU. The first arithmetic part 13a1 executes the program while referring to the data stored in the first memory 13a2, whereby the first apparatus 10a executes various processes such as a color conversion process, a half-tone process, etc.

The first communication interface 13a3 is connected to the second communication interface 13b3 and the external device 100 to be capable of communicating with the second communication interface 13b3 and the external device 100. Since the first controller 13a and the second controller 13b can communicate with each other via the first communication interface 13a3 and the second communication interface 13b3, the first controller 13a and the second controller 13b cooperate to control the printing apparatus 10. Further, the first controller 13a obtains data such as the image data of print image B, etc., from the external device 100 via the first communication interface 13a3. The image data is data which represents an image to be printed, such as raster data.

### Head

As depicted in FIG. 3, the plurality of heads 20 includes, for example, a first head 20a, a second head 20b, and a third head 20c. Note that the number of the kinds of the head 20 is not limited to three, and may be one, two, or four or more.

The first head 20a has one or more first chips 21a1 and 21a2, and a plurality of first nozzles 22a. The plurality of first nozzles 22a ejects, for example, an ink of a predetermined basic color. The basic color is, for example, a process color and includes cyan, magenta, yellow, and black.

The plurality of first nozzles 22a are aligned along the front-rear direction at equal distances so as to form a row. A row of the first nozzles 22a which eject the cyan ink, a row of the first nozzles 22a which eject the magenta ink, a row of the first nozzles 22a which eject the yellow ink, and a row of the first nozzles 22a which eject the black ink are disposed side by side in the left-right direction.

The first nozzles 22a are open in the lower surface of each of the first chips 21a1 and 21a2. The first chip 21a1 is disposed obliquely to the left and in front of the first chip 21a2. Further, the first chip 21a1 and the first chip 21a2 are disposed to be shifted in the front-rear direction so that a rear part of the first chip 21a1 and a front part of the first chip 21a2 overlap as seen along the left-right direction. By disposing the first chip 21a1 and the first chip 21a2 in this manner, the size of the row of the first nozzles 22a in the front-rear direction can be increased. In this row, the first nozzles 22a in the first chip 21a1 and the first nozzles 22a in the first chip 21a2 are aligned at the equal distances in the front-rear direction.

The second head 20b has one or more second chips 21b1 and 21b2 and a plurality of second nozzles 22b. The plurality of second nozzles 22b ejects, for example, an ink of a special color. The special color is a color different from the basic color, and includes, for example, a metallic color such as gold, silver, and copper, a pearlescent color, and a fluorescent color. The plurality of second nozzles 22b are aligned along the front-rear direction at equal distances so as to form a row.

The second nozzles 22b are open in the lower surface of each of the second chips 21b1 and 21b2. The second chip 21b1 is disposed obliquely to the left and in front of the second chip 21b2. Further, the second chip 21b1 and the second chip 21b2 are disposed to be shifted in the front-rear direction so that a rear part of the second chip 21b1 and a front part of the second chip 21b2 overlap as seen along the left-right direction. By disposing the second chip 21b1 and the second chip 21b2 in this manner, the size of the row of the second nozzles 22b in the front-rear direction can be increased. In this row, the second nozzles 22b in the second chip 21b1 and the second nozzles 22b in the second chip 21b2 are aligned at the equal distances in the front-rear direction.

The third head 20c has one or more third chips 21c1 and 21c2 and a plurality of third nozzles 22c. The plurality of third nozzles 22c ejects, for example, an ink of a base color. The base color is a color different from the basic color and the special color, and includes, for example, white. The plurality of third nozzles 22c are aligned along the front-rear direction at equal distances so as to form a row.

The third nozzles 22c are open in the lower surface of each of the third chips 21c1 and 21c2. The third chip 21c1 is disposed obliquely to the left and in front of the third chip 21c2. Further, the third chip 21c1 and the third chip 21c2 are disposed to be shifted in the front-rear direction so that a rear part of the third chip 21c1 and a front part of the third chip 21c2 overlap as seen along the left-right direction. By disposing the third chip 21c1 and the third chip 21c2 in this manner, the size of the row of the third nozzles 22c in the front-rear direction can be increased. In this row, the third nozzles 22c in the third chip 21c1 and the third nozzles 22c in the third chip 21c2 are aligned at the equal distances in the front-rear direction.

### Printing Process

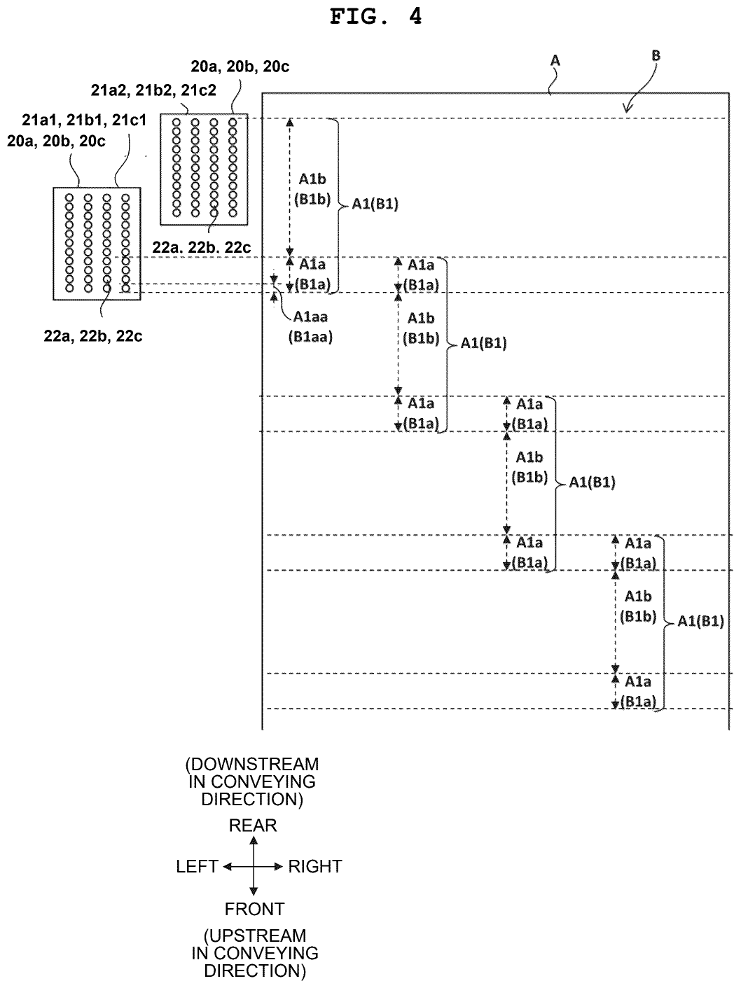

As depicted in FIG. 4, the second controller 13b executes a printing process on the print medium A based on the image data of the print image B, and performs a pass operation and a conveying operation in the printing process. In the pass operation, the second controller 13b cause the heads 20 to eject the ink from the plurality of the nozzles 22 of the heads 20 to a partial area A1 of the print medium A while moving the heads 20 in the left-right direction based on partial image data of a partial image B1. As a result, dots are formed in the partial area A1, and the partial image B1 composed of the dots is formed. In the conveying operation, the second controller 13b cause the conveyor 12 to convey the print medium A rearward with a conveyance amount by which an overlap area A1a of the partial area A1 as an object of the current pass operation overlaps with an overlap area A1a of the partial area A1 as an object of the pass operation performed last time (hereinafter referred to as “last pass operation” in some cases). As a result, a print image B constructed of a plurality of partial images B1 is formed.

This partial area A1 is a partial area of the print medium A and has an overlap area A1a and a non-overlap area A1b. The overlap area A1a is a partial area of the partial area A1 and overlaps with another overlap area A1a. The non-overlap area A1b is an area of the partial area A1 other than the overlap area A1a and does not overlap with another partial area A1. The overlap area A1a and the non-overlap area A1b are adjacent to each other in the front-rear direction in the partial area A1.

The partial image data is partial data of the image data and represents the partial image B1. The partial image B1 is a partial image of the print image B and is formed in the partial area A1 of the print medium A by the pass operation. The partial image B1 has an overlap image B1a and a non-overlap image B1b. The overlap image B1a is a partial area of the partial image B1 and is formed in the overlap area A1a of the partial area A1 by the pass operation, and overlaps with another overlap image B1a adjacent to the overlap image B1a. The non-overlap image B1b is a partial area of the partial image B1 and is an area different from the overlap image B1a, and is formed in the non-overlap area A1b of the partial area A1 by the pass operation, and does not overlap with another partial image B1.

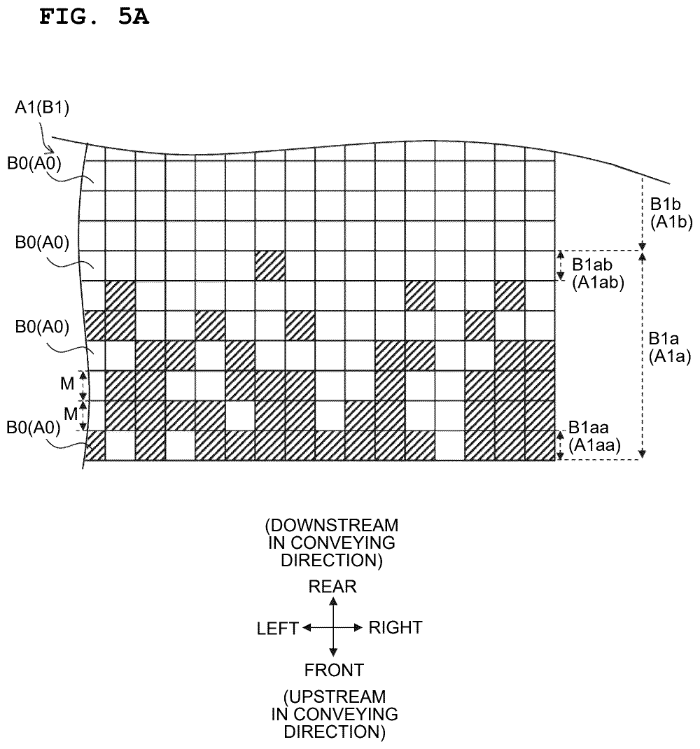

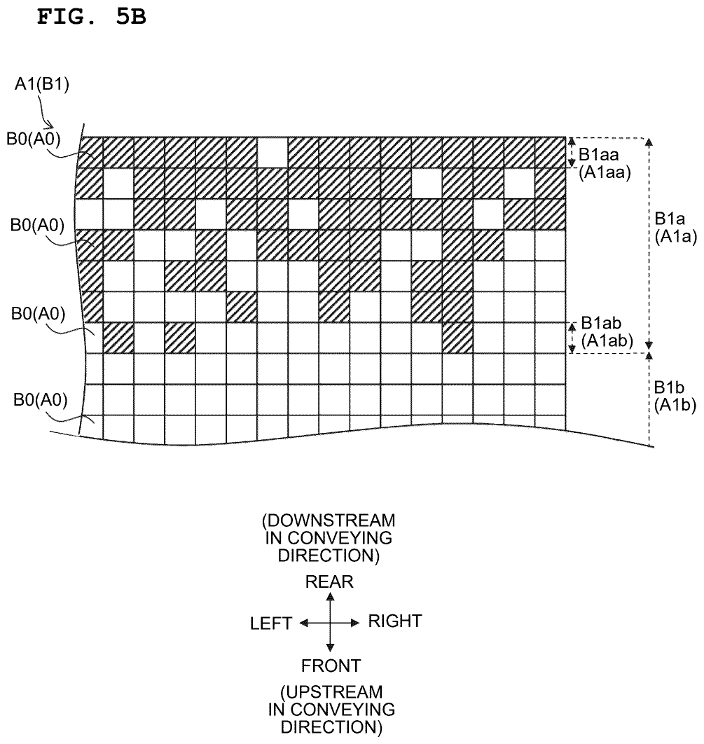

Further, as depicted in FIG. 5A, the partial image B1 is constructed of a plurality of pixels B0. The plurality of pixels B0 has a pixel B0 with a dot and a pixel B0 without a dot. The plurality of pixels B0 are arranged in a checkerboard pattern in the front-rear direction and the left-right direction. A pixel row, which is a row of pixels B0 aligned in the left-right direction, corresponds to one nozzle 22, in the pass operation. The pixel B0 corresponds to a pixel area A0 in the partial area A1. Therefore, the nozzle 22 moving in the left-right direction ejects the ink one by one to the pixel areas A0 in the row of the pixel areas A0, and a dot is formed one by one with respect to the plurality of pixels B0 in the pixel row.

Note that in the following, a partial area A as the object of a kth (“k” is a natural number) pass operation, which is the current pass operation, and a partial image B1 formed in this partial area A1 are referred to with “kth”, in some cases. A partial area A1 as the object of a (k+1)th pass operation, which is a pass operation to be performed next to the current pass operation, and a partial image B1 formed in this partial area A1 are referred to with “(k+1)th”, in some cases.

Further, in the printing process, the ink of the base color is ejected from the third nozzles 22c of the third head 20c to the print medium A, and a base is printed with the ink of the base color on the print medium A. Then, the ink of the basic color is ejected from the first nozzles 22a of the first head 20a to the base, and the ink of the special color is ejected from the second nozzles 22b of the second head 20b to the base. The ink of the basic color and the ink of the special color form the print image B on the base. Note that a print method of the base is same or similar to a print method of the print image B. Furthermore, the print image B may be printed on the print medium A, without printing the base.

As depicted in FIG. 4, by the pass operation of the first head 20a, the ink of the basic color is ejected from the first nozzles 22a of the first chips 21a1, 21a2 of the first head 20a, and the partial image B1 is formed in the partial area A1. Here, a kth overlap area A1a of a kth partial area A1 as the object of a kth pass operation is overlapped with a (k+1)th overlap area A1a of a (k+1)th partial area A1 as the object of a (k+1)th pass operation. Therefore, a kth overlap image B1a of a kth partial image B1 is overlapped with a (k+1)th overlap image B1a of a (k+1)th partial image B1. Further, in a case where the print medium A is conveyed rearward, the kth overlap image B1a is a front part, of the kth partial image B1, which is on the upstream in the conveying direction, and the (k+1)th overlap image B1a is a rear part, of the (k+1)th partial image B1, which is on the downstream in the conveying direction.

Further, in a case where the first chip 21a1 is disposed in front of the first chip 21a2, the kth overlap image B1a is formed by the ink ejected from the first chip 21a1, and the (k+1)th overlap image B1a is formed by the ink ejected from the first chip 21a2. Note that, similarly to the first head 20a, a kth overlap image B1a formed by the ink from the second chips 21b1 and 21b2 and a (k+1)th overlap image B1a formed by the ink from the second chips 21b1 and 21b2 also overlap with each other. Furthermore, similarly to the first head 20a, a kth overlap image B1a formed by the ink from the third chips 21c1 and 21c2 and a (k+1)th overlap image B1a formed by the ink from the third chips 21c1 and 21c2 also overlap with each other.

### Mask

In such a manner, in the printing process, a kth overlap image B1a on the upstream in the conveying direction in a kth partial image B1 as the object of the kth pass operation in an example of FIG. 5A is overlapped with a (k+1)th overlap image B1a on the downstream in the conveying direction in a (k+1)th partial image B1 as the object of the (k+1)th pass operation in an example of FIG. 5B. A mask is applied to the image data of the partial image B1 so that the ink is ejected in one of the kth pass operation and the (k+1)th pass operation and the ink is not ejected in the other of the kth pass operation and the (k+1)th pass operation, to a pixel area A0, of the print medium A, which corresponds to pixels B0 which overlap each other in the kth overlap image B1a and the (k+1)th overlap image B1a. As a result, a mask part is disposed complementarily to the kth overlap image B1a and the (k+1)th overlap image B1a which overlap each other.

The mask is applied to the partial image data of the overlap image B1a so as not to eject the ink from a part of the plurality of nozzles 22 in the pass operation. The mask includes a mask part configured to cause the ink not to be ejected from the nozzles 22 corresponding to the overlap image B1a in the pass operation. Since a dot is formed by the ink ejection with respect to each of the pixels B0 of the overlap image B1a, the mask part is applied to the pixels B0 one by one. The mask part causes the ink not to be ejected from nozzles 22 corresponding respectively to pixels B0 which are hatched in FIGS. 5A and 5B.

In the kth partial image B1 of FIG. 5A, the kth overlap image B1a is disposed upstream of a kth non-overlap area B1b in the conveying direction. In the (k+1)th partial image B1 of FIG. 5B, a (k+1)th overlap image B1a is disposed downstream of a (k+1)th non-overlap area B1b in the conveying direction. In a case where the print medium A is conveyed rearward, the kth overlap image B1a is a front part of the kth partial image B1 including a front end of the kth partial image B1, and includes, for example, seven pixel rows of pixels B0 rearward from the front end of the kth partial image B1. The (k+1)th overlap image B1a is a rear part of the (k+1)th partial image B1 including a rear end of the (k+1)th partial image B1, and includes, for example, seven pixel rows of pixels B0 forward from the rear end of the (k+1)th partial image B1. In this case, the ejection in the pass operation of seven nozzles 22 corresponding respectively to the seven pixel rows of the kth overlap image B1a and the ejection in the pass operation of seven nozzles 22 corresponding respectively to the seven pixel rows of the (k+1)th overlap image B1a are restricted by the mask parts.

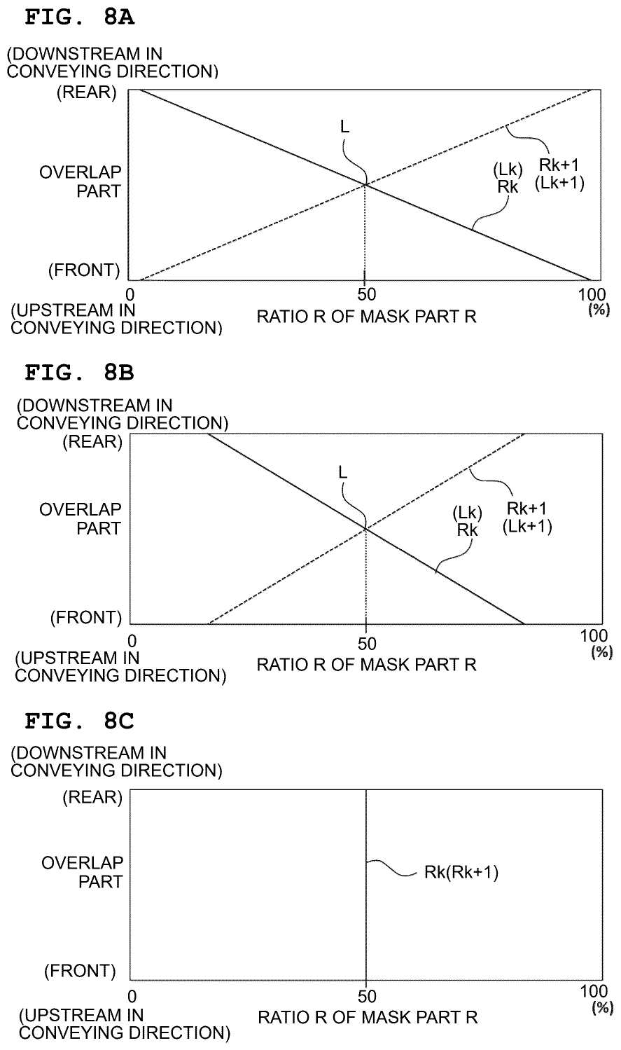

Further, the mask parts are disposed complementarily with respect to the kth overlap image B1a and the (k+1)th overlap image B1a. Therefore, as depicted in FIG. 8A, the total of a ratio Rk of the mask part with respect to the kth overlap image B1a and a ratio Rk+1 of the mask part with respect to the (k+1)th overlap image B1a is 100%. The ratio R of the mask part with respect to the overlap image B1a is a number of pixels B0 to which the mask part is applied to a number of pixels B0 in the pixel row in the overlap image B1a.

Further, since the non-overlap image B1b does not overlap with another partial image B1, the mask is not applied to the image data of the non-overlap image B1b. Therefore, a ratio R of the mask part with respect to the non-overlap image B1b is a ratio of the number of pixels B0 to which the mask part is applied to the number of pixels B0 in the pixel row in the non-overlap image B1b, and the ratio R is 0%.

### Type of Mask

The mask has a mask pattern of a changing type and a mask pattern of a constant type, depending on whether the ratio R of the mask part changes.

In the mask pattern of the changing type, as depicted in the examples of FIG. 5A and FIG. 5B, the number of the mask part (shaded pixel B0) to the overlap image B1a increases further at a location in the overlap image B1a farther away from the non-overlap image B1b along the conveying direction. In other words, in the mask pattern of the changing type, the ratio R of the mask part changes along the conveying direction. In the example of FIG. 5A, the kth overlap image B1a is disposed in front of and upstream in the conveying direction of the kth non-overlap area B1b, and the number of the mask part with respect to the kth overlap image B1a becomes greater further at a location farther away frontward from the kth non-overlap area B1b. In the example of FIG. 5B, the (k+1)th overlap image B1a is disposed behind and downstream in the conveying direction of the (k+1)th non-overlap image B1b, and the number of the mask part with respect to the (k+1)th overlap image B1a becomes greater further at a location farther away rearward from the (k+1)th non-overlap area B1b. As depicted in FIG. 8A, the ratio Rk of the mask part with respect to the kth overlap image B1a becomes greater further at the location farther away frontward from the kth non-overlap area B1b. The ratio Rk+1 of the mask part with respect to the (k+1)th overlap image B1a becomes greater at the location farther away rearward from the (k+1)th non-overlap area B1b.

In such a manner, an upstream mask pattern of the changing type in which the number of mask part increases frontward is applied to the kth overlap area B1a on the upstream, and a downstream mask pattern of the changing type in which the number of the mask part increased rearward is applied to the (k+1)th overlap image B1a on the downstream. In the upstream mask pattern and the downstream mask pattern, the mask parts are disposed complementarily.

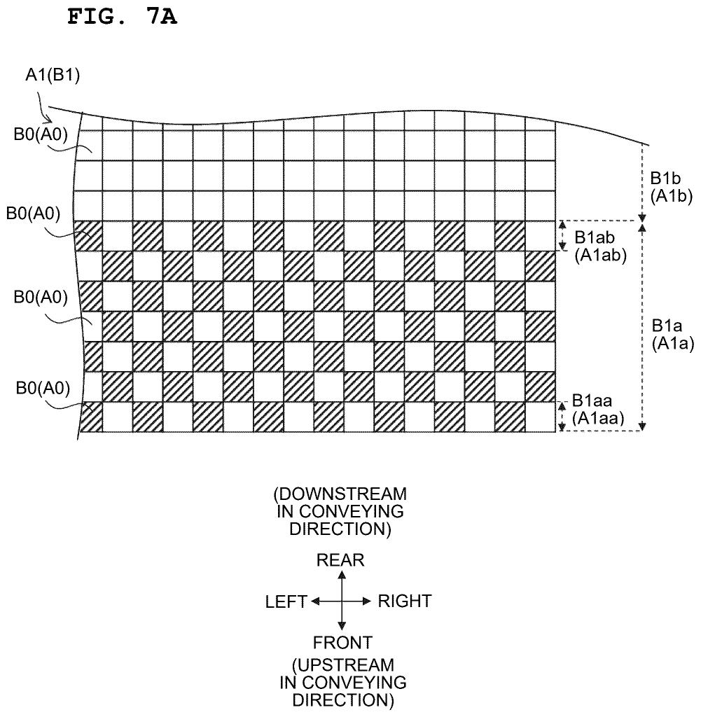

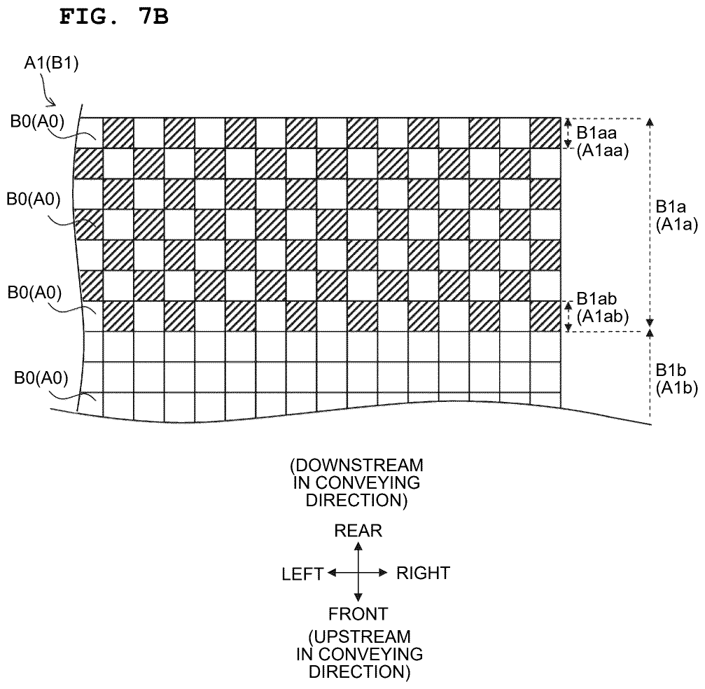

In the mask pattern of the constant type, as depicted in the example of FIG. 7A and FIG. 7B, the number of the mask part in the overlap image B1a does not change and is constant along the conveying direction. In other words, in the mask pattern of the constant type, the ratio R of the mask part is constant along the conveying direction. Therefore, as depicted in FIG. 8C, the ratio Rk of the mask part with respect to the kth overlap image B1a and the ratio Rk+1 of the mask part with respect to the (k+1)th overlap image B1a are constant along the conveying direction, and each of the ratio Rk and the ratio Rk+1 is, for example, 50%.

In this case, an upstream mask pattern of the constant type is applied to the kth overlap image B1a on the upstream in the conveying direction, and a downstream mask pattern of the constant type is applied to the (k+1)th overlap image B1a on the downstream in the conveying direction. In the upstream mask pattern and the downstream mask pattern, the mask parts are disposed complementarily.

In a case where the mask pattern of the changing type as described above is applied to the image data of the partial image B1, banding such as color unevenness is less likely to occur than in a case where the mask pattern of the constant type is applied to the image data of the partial image B1. However, the number of the mask part with respect to a distant end part B1aa, as an end part (pixel row), of the overlap image B1a, which is distant from the non-overlap image B1b, is greater in the mask pattern of the changing type than in the mask pattern of the constant type. For this reason, ejection frequency of the nozzle 22 with respect to the distant end part B1aa is lower in the mask pattern of the changing type than in the mask pattern of the constant type. The lower the ejection frequency is, the higher the risk of ink drying in the nozzle 22 is.

Further, the ejection frequency of the ink of the special color from the second nozzles 22b is likely to be lower than the ejection frequency of the ink of the basic color from the first nozzles 22a. Therefore, the mask patterns in which the mask parts with respect to the distant end part B1aa of the overlap image B1a have mutually different ratios R are applied in the pass operation in accordance with the information on the drying risk of the ink in the second nozzles 22b.

### Kind of Mask Pattern

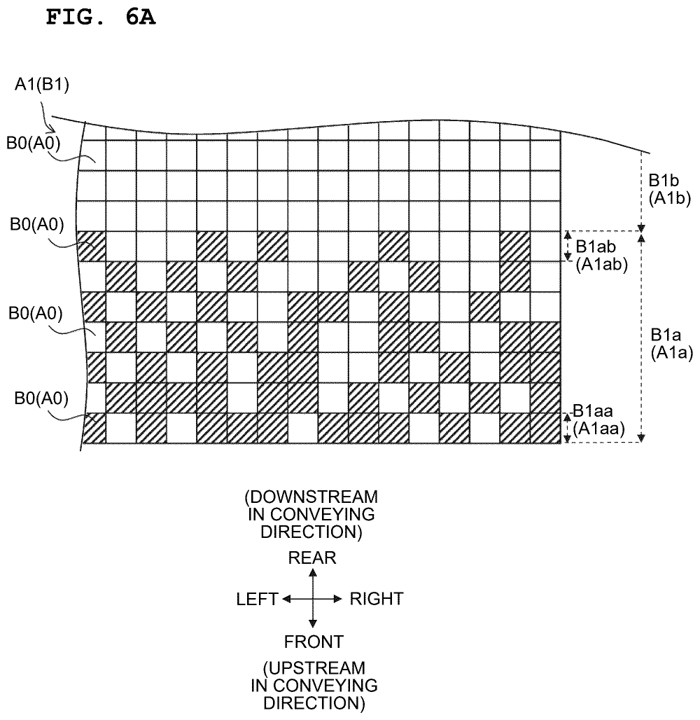

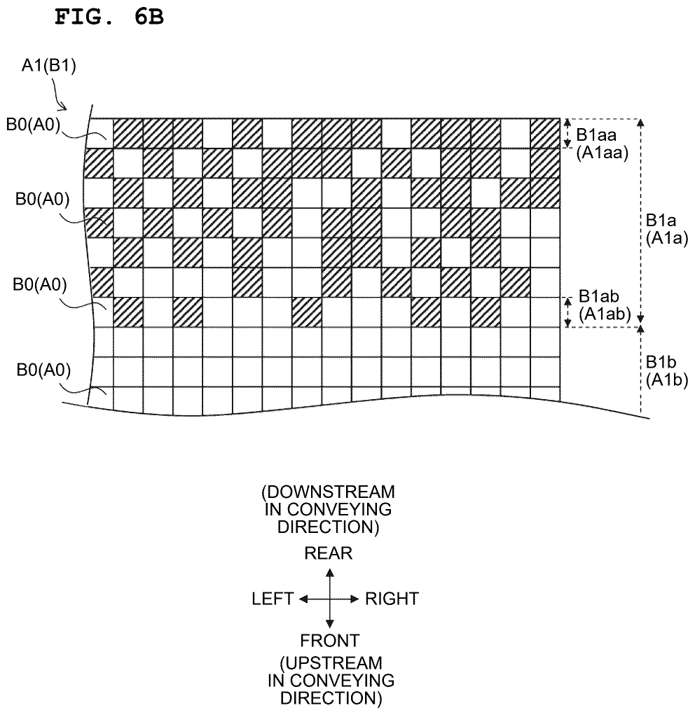

The mask pattern has a first mask pattern of the example in FIG. 5A and a second mask pattern of an example in FIG. 6A. The second mask pattern has mask parts with respect to a distant end part B1aa which is included in the overlap area B1a and which is far from the non-overlap image B1b in the conveying direction; and the number of the mask parts with respect to the distant end part B1aa in the second mask pattern is smaller than the number of mask parts with respect to the distant end part B1aa in the first mask pattern.

Further, the first mask pattern is of the mask pattern of the changing type as depicted in the examples of FIGS. 5A and 5B. The second mask pattern has a second mask pattern X of the changing type as depicted in the example of FIGS. 6A and 6B, and a second mask pattern Y of the constant type as depicted in the example of FIGS. 7A and 7B. However, the second mask pattern may have at least one of the changing type and the constant type. These mask patterns are stored in advance in the second memory 13b2.

The first mask pattern of the changing type and the second mask pattern X of the changing type have a greater banding reducing effect than the second mask pattern Y of the constant type. Further, the number of the mask part with respect to the distant end part B1aa of the overlap image B1a is greater in the first mask pattern than in the second mask pattern X. For this reason, as depicted in FIG. 8A and FIG. 8B, a change rate of the ratio R of the mask part with respect to the overlap image B1a along the conveying direction (inclination of each of a ratio line (mask ratio line) Lk and a ratio line Lk+1 each of which is a line representing the ratio R) is greater in the first mask pattern than in the second mask pattern X. As a result, the first mask pattern has the greater banding reducing effect than the second mask pattern X. Accordingly, the banding reducing effect increases in the order of the second mask pattern Y, the second mask pattern X, and the first mask pattern.

Furthermore, the ratio R of the mask part with respect to the distant end part B1aa of the overlap image B1a becomes smaller in the order of the first mask pattern, the second mask pattern X, and the second mask pattern Y. As a result, an ink drying reducing effect becomes greater in the order of the first mask pattern, the second mask pattern X, and the second mask pattern Y. In such a manner, the masks having the mask patterns of which ink drying reducing effects are different from each other and of which banding reducing effects are different from each other are applied to the image data of the overlap image B1a, in accordance with the information on the drying risk of the ink in the second nozzles 22b.

### Information on Drying Risk

The information on the drying risk is based on the ejection frequency of the ink from the nozzle 22. Regarding this ejection frequency, the ejection frequency of the second nozzle 22b ejecting the ink of the special color becomes lower than the ejection frequency of the first nozzle 22a ejecting the ink of the basic color, in some cases. In this case, the ejection frequency of the second nozzle 22b of the nozzles 22 is used with respect to information on the drying risk.

Further, by applying the mask to the overlap image B1a, the ejection frequency of the ink from the nozzles 22 with respect to the overlap image B1a is likely to be lower than the ejection frequency of the ink from the nozzles 22 with respect to the non-overlap image B1b in the partial image B1. For this reason, the ejection frequency of second nozzles 22b included in the second nozzles 22b and corresponding to the overlap image B1a is used with respect to the information on the drying risk.

Further, the kth overlap image B1a on the upstream in the current kth pass operation overlaps with the (k+1)th overlap image B1a on the downstream in the next (k+1)th pass operation. The masks having the mutually same mask patterns are applied, respectively, to these kth overlap image B1a and (k+1)th overlap image B1a. Therefore, the ejection frequency of the second nozzles 22b corresponding to the kth overlap image B1a and the ejection frequency of the second nozzles 22b corresponding to (k+1)th overlap image B1a are used with respect to information on the drying risk.

In the example of FIG. 4, the second nozzles 22b corresponding to the kth overlap image B1a are seven second nozzles 22b located rearward from the front end in the second chip 21b1. The second nozzles 22b corresponding to the (k+1)th overlap image B1a are seven second nozzles 22b located forward from the rear end in the second chip 21b2. In this case, for example, an average value of the ejection frequencies of the fourteen second nozzles 22b may be used with respect to the information on the drying risk.

The ejection frequency of the ink from the second nozzle 22b is, for example, the number of times the ink is ejected from the second nozzle 22b per unit time. This ejection frequency is the quotient (D/E) obtained by dividing the number of ejection times D of the second nozzle 22b in a predetermined time E by the predetermined time E. This predetermined time E is, for example, a predetermined time until the last pass operation of the current printing process, such as a time from a predetermined point of time to the last pass operation, or a predetermined time going back from the last pass operation, etc.

The number of ejection times D of the second nozzle 22b is a total of a number of ejection times D1 up to the printing process performed last time (hereinafter referred to as “last printing process” in some cases) and a number of ejection times D2 up to the last pass operation in the current printing process. The ejection of the ink from the second nozzle 22b up to the last printing process has already been executed. Therefore, every time the ink is ejected from the second nozzle 22b, the number of ejection times of the second nozzle 22b is stored in the second memory 13b2. Therefore, the number of ejection times D1 of the second nozzle 22b up to the last printing process is obtained from the second memory 13b2.

On the other hand, there are cases where the ink ejection from the second nozzle 22b up to the last pass operation in the current printing process has not yet been executed. In this case, the number of ejection times D2 of the second nozzle 22b up to the last pass operation is obtained based on the image data of the partial image B1 used in the pass operation. Here, in a case where the image data is expressed as presence or absence of dots, the ink is ejected to a pixel B0 with dot, and the ink is not ejected to a pixel B0 without dot. Therefore, the number of the pixel B0 with dot corresponds to the number of ejection times.

A relationship between the ejection frequency of the ink from the second nozzle 22b and the information on the drying risk is stored in advance in the second memory 13b2. For example, the information on the drying risk is “medium” (that is, the drying risk is a medium level) with respect to ejection frequency equal to or greater than a first predetermined value and less than a second predetermined value which is greater than the first predetermined value; the information on the drying risk is “high” (that is, the drying risk is higher than the medium level) with respect to ejection frequency less than the first predetermined value; and the information on the drying risk is “low” (that is, the drying risk is lower than the medium level) with respect to ejection frequency equal to or greater than the second predetermined value.

Note that in the foregoing description, the information on the drying risk is obtained based on the ejection frequency of the second nozzles 22b corresponding to the kth overlap image B1a and based on the ejection frequency of the second nozzles 22b corresponding to the (k+1)th overlap image B1a which overlaps with the kth overlap image B1a. However, the ink easily dries in the second nozzle 22b corresponding to the distant end part B1aa of the overlap image B1a. Therefore, the information on the drying risk may be obtained based on the ejection frequency of the second nozzle 22b with respect to the distant end part B1aa of the kth overlap image B1a and based on the ejection frequency of the second nozzle 22b with respect to the distant end part B1aa of the (k+1)th overlap image B1a. Further, the information on the drying risk may be obtained based on the ejection frequencies of the first nozzles 22a and the second nozzles 22b each corresponding to the kth overlap image B1a and the (k+1)th overlap image B1a which overlap with each other.

### Control Method of Printing Apparatus

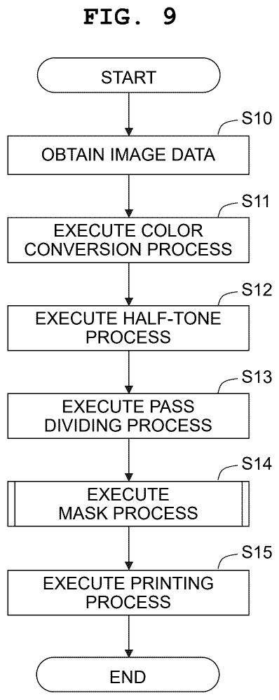

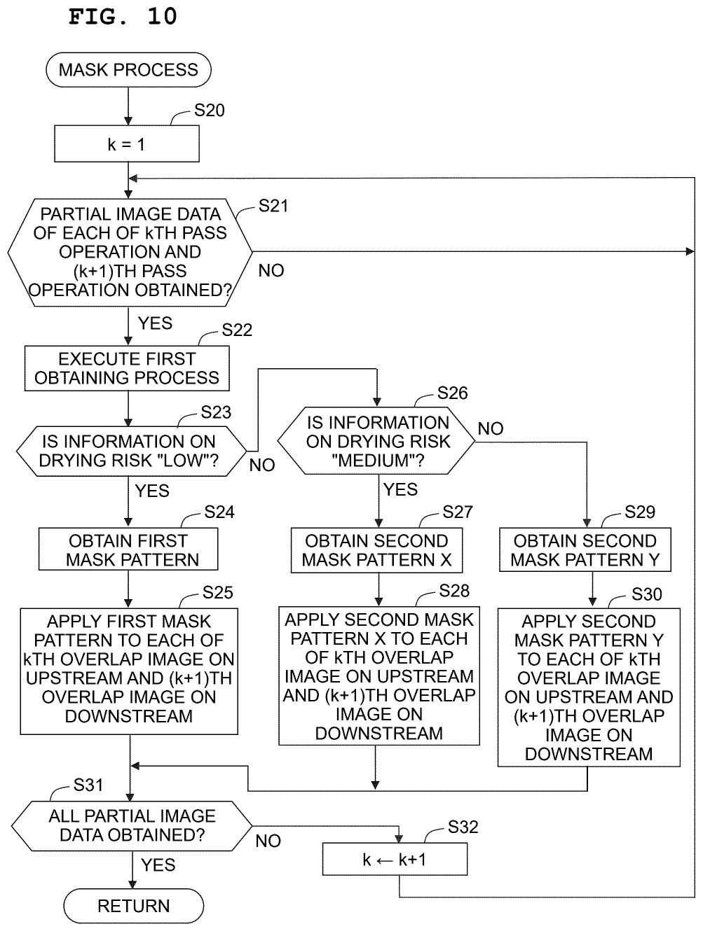

The printing apparatus 10 is controlled by the first controller 13a and the second controller 13b in accordance with a flowchart depicted in an example of FIG. 9. First, the first controller 13a of the first apparatus 10a obtains the image data of the print image B from the first communication interface 13a3 or the first memory 13a2 (step S10).

Next, the first controller 13a executes a color conversion process with respect to the image data of the print image B (step S11). In the color conversion process, the first controller 13a converts RGB image data into image data relating to each of colors which can be printed by the printing apparatus 10 (for example, the basic colors which are CMYK and the special color).

Next, the first controller 13a executes a half-tone process with respect to the image data relating to each of the colors (step S12). In the half-tone process, the first controller 13a obtains image data converted into the presence or absence of dot according to the density of the pixels B0 of the print image B, and transmits the image data to the second apparatus 10b. The image data expressed by the presence or absence of dot may be, for example, binary data, or may be four-value data further including the size of the dot.

Next, the second controller 13b of the second apparatus 10b obtains the image data subjected to the half-tone process from the first controller 13a and executes a pass dividing process with respect to the image data (step S13). In the pass dividing process, the second controller 13b divides the image data of the print image B into the multiple partial image data of each of the pass operations and stores the multiple partial image data each corresponding to one of a plurality of partial images B1 in the second memory 13b2. Here, each of the plurality of partial images B1 is assigned to one of the pass operations so that the kth overlap image B1a on the upstream in the conveying direction in the kth partial image B1 of the kth pass operation and the k+1th overlap image B1a on the downstream in the conveying direction in the (k+1)th partial image B1 of the (k+1)th pass operation overlap with each other.

Further, with the division of the image data, the print medium A is divided into a plurality of partial areas A1 each being as the object of one of the pass operations. Here, each of the plurality of partial areas A1 is assigned to one of the pass operations so that the kth overlap area A1a on the upstream in the conveying direction in the kth partial area A1 as the object of the kth pass operation and the (k+1)th overlap area A1a on downstream in the conveying direction in the (k+1)th partial area A1 as the object of the (k+1)th pass operation overlap with each other.

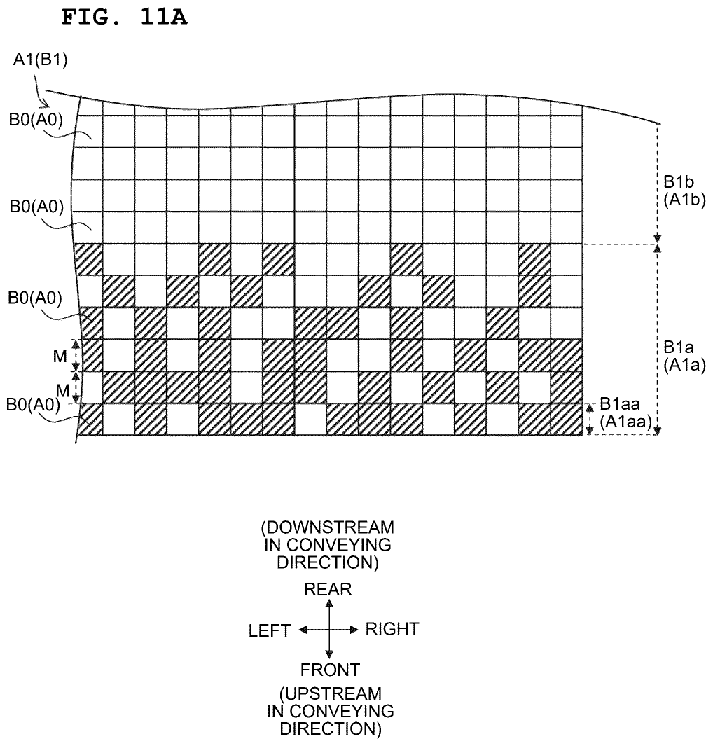

Next, the second controller 13b executes a mask process of applying the mask to the partial image data of the partial image B1 (step S14). The mask process is executed by the second controller 13b according to a flowchart depicted in an example of FIG. 10. In this mask process, the second controller 13b resets the “k” to “1” (step S20) and obtains the partial image data of the kth pass operation and the partial image data of the (k+1)th pass operation from the second memory 13b2 (step S21).

Next, the second controller 13b executes a first obtaining process of obtaining the information on the drying risk of the ink in the plurality of the nozzle 22 (step S22). In this first obtaining process, the second controller 13b obtains the second nozzles 22b corresponding to an upstream kth overlap image B1a and the second nozzles 22b corresponding to a downstream (k+1)th overlap image B1a overlapping with each other. Then, the second controller 13b obtains the number of ejection times D1 of the second nozzles 22b up to the last printing process from the second memory 13b2. Further, the second controller 13b obtains the number of ejection times D2 of the second nozzles 22b in the first pass operation up to the last pass operation in the current printing process, based on the partial image data of each of these pass operations. Note that each of the number of ejection times DI and the number of ejection times D2 may be the number of ejection times obtained taking the changing of the number of ejection times owing to the mask process in consideration. Then, the second controller 13b obtains the quotient obtained by dividing the total D of the number of ejection times D1 up to the last printing process and the number of ejection times D2 up to the last pass operation by the predetermined time E, as the ejection frequency of the second nozzles 22b. Then, the second controller 13b obtains information on the drying risk corresponding to the ejection frequency of the second nozzles 22b from the second memory 13b2.

Next, the second controller 13b determines whether the information on the drying risk is “low” (step S23). In a case where the second controller 13b determines that the information on the drying risk is not “low” (step S23: NO), the second controller 13b determines whether the information on the drying risk is “medium” (step S26). Based on the determination results in steps S23 and S26, the second controller 13b executes a second obtaining process of obtaining the mask pattern of the mask to be applied to the image data of each of the kth partial image B1 and the (k+1)th partial image B1, based on the information on the drying risk.

That is, in the second obtaining process, in a case where the second controller 13b determines that the information on the drying risk is “low” (step S23: YES), the second controller 13b obtains the first mask pattern as the mask to be applied to the image data of each of the kth partial image B1 and the (k+1)th partial image B1 (step S24). In this manner, in a case where the ink in the second nozzles 22b is not easily dried, the first mask pattern with the small ink drying reducing effect is used.

Further, the second controller 13b applies the mask of the first mask pattern to each of the kth overlap image B1a on the upstream and the (k+1)th overlap image B1a on the downstream. Here, in a case where a mask part of the mask corresponds to a pixel B0 with dot which is included in the pixels B0 in the overlap images B1a, this pixel B0 is converted from the pixel B0 with dot to a pixel B0 without dot. Due to this mask part, the ink is not ejected to a pixel area A0, of the print medium A, which corresponds to the pixel B0 in the kth pass operation and in the (k+1)th pass operation. Then, the second controller 13b obtains the partial image data of each of the kth partial image B1 and the (k+1)th partial image B1 to which the mask of the first mask pattern has been applied, and stores the partial image data B1 in the second memory 13b2 (step S25).

Further, in the second obtaining process, in a case where the second controller 13b determines that the information on the drying risk is “medium” (step S23: NO, step S26: YES), the second controller 13b obtains the second mask pattern X as the mask to be applied to the image data of each of the kth partial image B1 and the (k+1)th partial image B1 (step S27). In this manner, in a case where the degree of dryness of the second nozzle 22b is at the medium level, the second mask pattern X with the ink drying reducing effect of the medium level is used.

Then, the second controller 13b applies the mask of the second mask pattern X to the kth overlap image B1a on the upstream and the (k+1)th overlap image B1a on the downstream which overlap with each other. Further, the second controller 13b obtains the partial image data of each of the kth partial image B1 and the (k+1)th partial image B1 to which the mask of the second mask pattern X has been applied, and stores the image data in the second memory 13b2 (step S28).

Further, in the second obtaining process, in a case where the second controller 13b determines that the information on the drying risk is “high” (step S23: NO, step S26: NO), the second controller 13b obtains the second mask pattern Y as the mask to be applied to the image data of each of the kth partial image B1 and the (k+1)th partial image B1 (step S29). In this manner, in a case where the ink in the second nozzles 22b easily dries, the second mask pattern Y, of which ink drying reducing effect is great, is used. This reduces the drying of the ink in the second nozzles 22b, and the unsatisfactory ejection of the ink from the second nozzles 22b can be reduced.

Furthermore, the second controller 13b applies the mask of the second mask pattern Y to the kth overlap image B1a on the upstream and the (k+1)th overlap image B1a on the downstream which overlap with each other. The second controller 13b then obtains the partial image data of each of the kth partial image B1 and the (k+1)th partial image B1 to which the mask of the second mask pattern Y has been applied, and stores the data in the second memory 13b2 (step S30).

Next, the second controller 13b determines whether all the partial image data of the second head 20b has been obtained (step S31). Here, in a case where the second controller 13b determines that all the partial image data of the partial images B1 has not been obtained (step S31: NO), the second controller 13b increments the “k” by one (step S32) and returns to step S21 so as to execute the process of step S21 and the subsequent processes. On the other hand, in a case where the second controller 13b determines that all the partial image data of the partial images B1 has been obtained (step S31: YES), the second controller 13b ends the mask process of step S14 in FIG. 9.

Next, the second controller 13b executes the printing process based on the partial image data to which the mask process has been executed (step S15). In the printing process, the second controller 13b executes the pass operation based on the partial image data to which the mask has been applied, and forms a partial image B1 in a partial area A1 of the print medium A. Then, the second controller 13b executes the conveying operation, and conveys the print medium A by the predetermined conveyance amount. As a result, the overlap area A1a of the partial area A1 as the object of the current pass operation overlaps with the overlap area A1a of the partial area A1 as the object of the last pass operation. Accordingly, the overlap image B1a of the partial image B1 by the current pass operation overlaps with the overlap image B1a of the partial image B1 by the last pass operation.

In this manner, in the printing apparatus 10, the second controller 13b executes the second obtaining process of obtaining the mask pattern of the mask to be applied to the image data of the overlap image B1a, based on the information on the drying risk. For example, in a case where the drying risk of the ink is high in the nozzles 22 corresponding to the overlap image B1a of the overlap image B1a, the second mask pattern of which number of the mask part is smaller than the number of the mask part of the first mask pattern is used with respect to the pass operation. As a result, the frequency of ejecting the ink from the nozzles 22 corresponding to the overlap image B1a tends to be high, so that the drying of the ink in the nozzles 22 is reduced and the unsatisfactory ejection of the ink is suppressed.

Further, in the printing apparatus 10, the information on the drying risk is based on the ejection frequency of the ink from the nozzle 22 in the pass operation(s) performed up to the last pass operation. As a result, the mask pattern applied to the current pass operation changes depending on the ejection frequency up to the last pass operation. Therefore, the drying of the ink in the nozzle 22 is more appropriately reduced, depending on the drying risk in the nozzle 22 up to the last pass operation, and the unsatisfactory ejection of the ink is suppressed.

Furthermore, in the printing apparatus 10, the information on the drying risk is based on the ejection frequency of the ink of the special color from the second nozzle 22b. The ejection frequency of the ink from the second nozzle 22b becomes lower than the ejection frequency of the ink from the first nozzle 22a, in some cases. In such a case, the drying of the ink in the second nozzle 22b is more appropriately reduced in accordance with the drying risk which is based on the ejection frequency of the ink of the special color from the second nozzle 22b, and the unsatisfactory ejection of the ink is suppressed.

Moreover, in the printing apparatus 10, the ratio R of the mask part with respect to the overlap image B1a increases further at a location, in the overlap image B1a, which is farther away from the non-overlap image B1b along the conveying direction, in the mask pattern applied to the image data of the overlap image B1a in the pass operation. The change rate of the ratio R of the mask part along the conveying direction (the inclination of each of the ratio line Lk and the ratio line Lk+1 representing the ratio R) is greater in the first mask pattern than in the second mask pattern X.

As a result, the ratio R of the mask part in a near end part Blab, which is an end part (pixel row) of the overlap image B1a near the non-overlap image B1b in the conveying direction, is smaller in the first mask pattern than in the second mask pattern. Therefore, the difference in the ratio R of the mask part between the non-overlap image B1b to which the mask is not applied and the near end part Blab of the overlap image B1a is smaller in the first mask pattern than in the second mask pattern. As a result, the banding reducing effect is greater in the first mask pattern than in the second mask pattern. By applying such a mask of the first mask pattern to the image data of the partial image B1 in the pass operation, the banding in the overlap image B1a can be suppressed.

On the other hand, the ratio R of the mask part in the distant end part B1aa, of the overlap image B1a, which is distant from the non-overlap image B1b in the conveying direction, is smaller in the second mask pattern than in the first mask pattern. As a result, the ink drying reducing effect is greater in the second mask pattern than in the first mask pattern. By applying such a mask of the second mask pattern to the image data of the partial image B1 in the pass operation, the drying of the ink in the nozzles 22 corresponding to the overlap image B1a can be suppressed.

Further, in the printing apparatus 10, the first mask pattern has the changing type in which the ratio R of the mask part changes along the conveying direction. The second mask pattern has at least one of the changing type and the constant type (that is, the changing type and/or the constant type). The ratio R of the mask part is constant along the conveying direction in the constant type. The changing type has the banding reducing effect greater than the banding reducing effect of the constant type, whereas the constant type has the ink drying reducing effect greater than the ink drying reducing effect of the changing type. By applying such a variety of types of the mask pattern to the image data of the partial image B1, both the reduction of the drying of ink and the reduction of banding can be realized.

In a printing apparatus 10 according to a first modification, the mask of the second mask pattern has a size in the conveying direction which is smaller than the size in the conveying direction of the mask of the first mask pattern. The conveyance amount of the print medium A in the conveying operation performed between the current pass operation and the next pass operation is greater in a case where the mask of the second mask pattern is applied to the image data of each of the overlap image B1a as the object of the current pass operation and the overlap image B1a as the object of the next pass operation, which overlap each other, than in a case where the mask of the first mask pattern is applied to the image data of each of the overlap image B1a as the object of the current pass operation and the overlap image B1a as the object of the next pass operation.

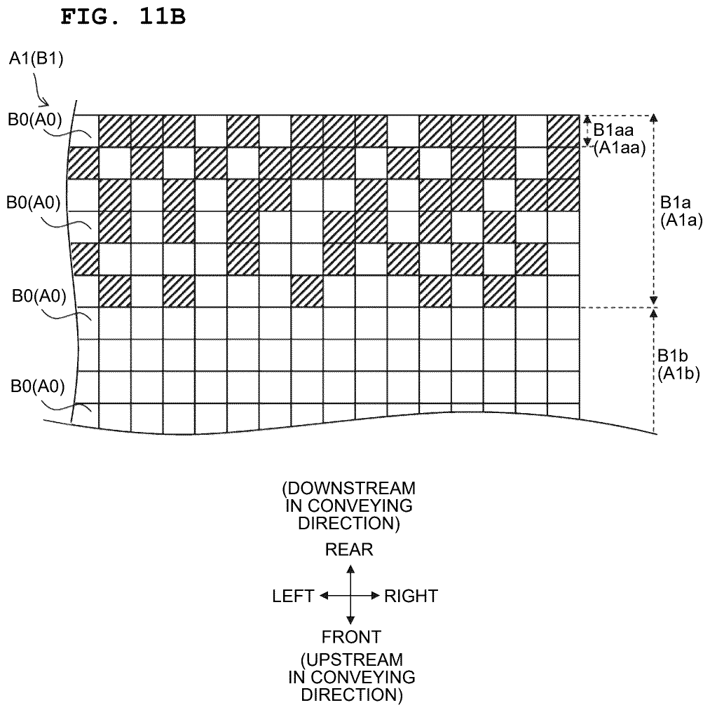

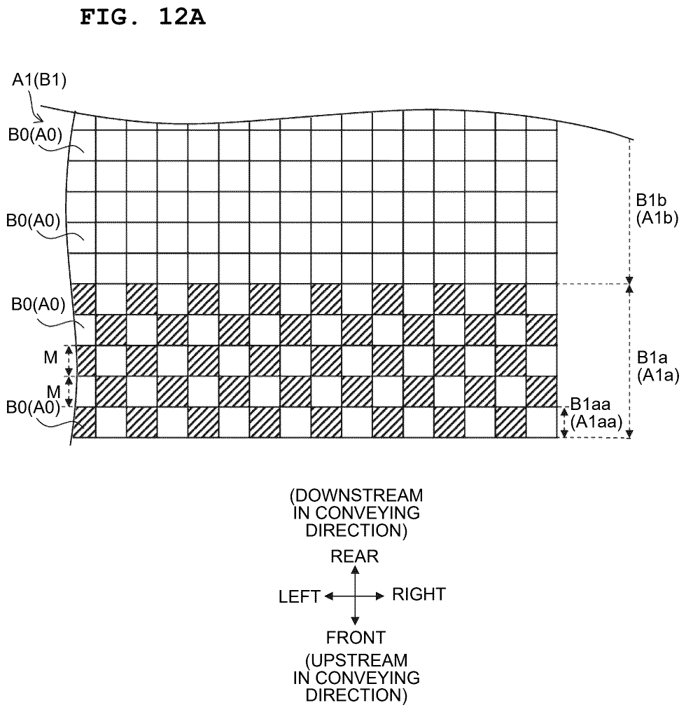

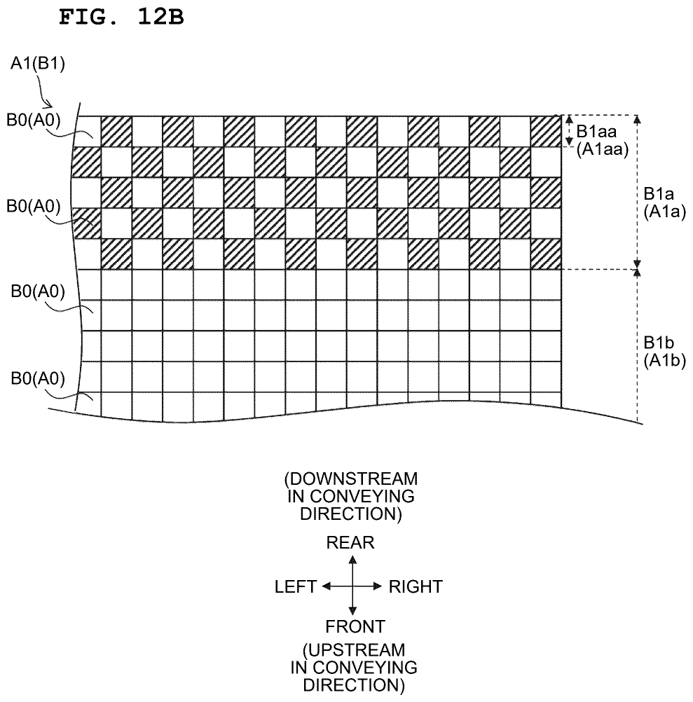

Specifically, the size of the mask of the mask pattern in the conveying direction corresponds, for example, to the size of the overlap image B1a to which the mask of the mask pattern is applied. This overlap image B1a includes a plurality of pixel rows each of which includes a plurality of pixels B0 arranged in the left-right direction, and a size of one pixel row in the conveying direction is defined as “M”. As depicted in the examples of FIG. 5A and FIG. 5B, the size of the mask in the conveying direction of the first mask pattern corresponds to the size of the seven pixel rows of the overlap image B1a, and the size is 7×M. As depicted in examples of FIG. 11A and FIG. 11B, the size in the conveying direction of the mask of the second mask pattern X corresponds to a size of six pixel rows of the overlap image B1a, and the size is 6×M. Further, as depicted in examples of FIG. 12A and FIG. 12B, a size in the conveying direction of the mask of the second mask pattern Y corresponds to a size of five pixel rows of the overlap image B1a, and the size is 5×M.

In this case, a conveyance amount of the print medium A in the conveying operation between the kth pass operation and the (k+1)th pass operation is determined so that the kth overlap image B1a on the upstream and the (k+1)th overlap image B1a on the downstream overlap each other. Therefore, the conveyance amount of the print medium A corresponds to a difference obtained by subtracting the size of the mask pattern applied to each of the kth overlap image B1a and the (k+1)th overlap image B1a, which overlap with each other, from the conveyance amount N. The conveyance amount N is a conveyance amount of the print medium A in a case where the kth partial image B1 and the (k+1)th partial image B1 do not overlap each other.

Accordingly, in a case where the first mask pattern is used with respect to the kth overlap image B1a and the (k+1)th overlap image B1a, the conveyance amount is a first conveyance amount (N−7×M). In a case where the second mask pattern X is used with respect to the kth overlap image B1a and the (k+1)th overlap image B1a, the conveyance amount is a second conveyance amount (N−6×M). In a case where the second mask pattern Y is used with respect to the kth overlap image B1a and the (k+1)th overlap image B1a, the conveyance amount is a third conveyance amount (N−5×M).

In this manner, the size of the mask in the conveying direction becomes smaller in the descending order of the first mask pattern, the second mask pattern X, and the second mask pattern Y. On the other hand, the conveyance amount of the print medium A becomes greater in the ascending order of the first conveyance amount, the second conveyance amount, and the third conveyance amount. The relationship between the mask pattern and the conveyance amount is stored in advance in the second memory 13b2.

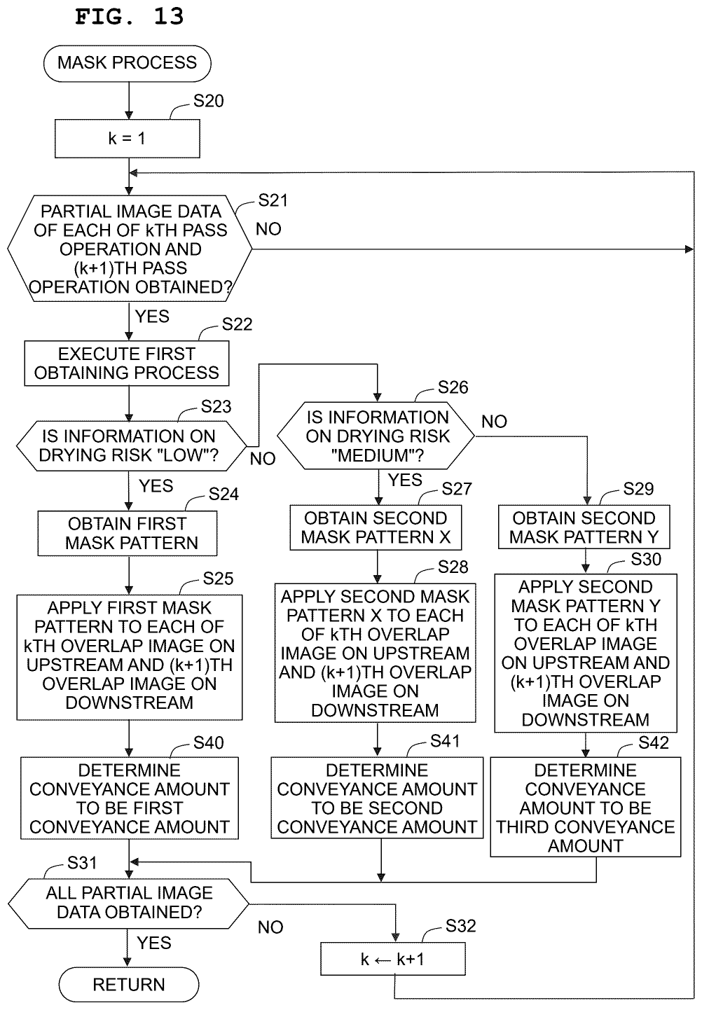

The mask process executed in the printing apparatus 10 according to the first modification is executed according to a flowchart depicted in an example of FIG. 13. In the flowchart of FIG. 13, operations of determining the conveyance amount of the print medium A in step S40, step S41 and step S42 are executed, respectively, after steps S25, S28, and S30 in FIG. 10.

That is, in a case where the second controller 13b determines that the information on the drying risk is “low” (step S23: YES), the second controller 13b obtains the first mask pattern with respect to the mask to be applied to the image data of each of the kth overlap image B1a and the (k+1)th overlap image B1a which overlap each other (step S24). Then, the second controller 13b obtains partial image data of each of the kth partial image B1 and the (k+1)th partial image B1 in which the mask of the first mask pattern is applied to these overlap images B1a, and stores the partial image data of each of the kth partial image B1 and the (k+1)th partial image B1 in the second memory 13b2 (step S25). Then, the second controller 13b determines the conveyance amount in the conveying operation of the print medium A between the kth pass operation and the (k+1)th pass operation to be the first conveying amount, and stores the first conveyance amount in the second memory 13b2 (step S40).

On the other hand, in a case where the second controller 13b determines that the information on the drying risk is “medium” (step S23: NO, S26: YES), the second controller 13b obtains the second mask pattern X as the mask to be applied to the image data of each of the kth overlap image B1a and the (k+1)th overlap image B1a which overlap with each other (step S27). Then, the second controller 13b obtains the partial image data of each of the kth partial image B1 and the (k+1)th partial image B1 in which the mask of the second mask pattern X has been applied to these overlap images B1a, and stores the partial image data of each of the kth partial image B1 and the (k+1)th partial image B1 in the second memory 13b2 (step S28). Then, the second controller 13b determines the conveyance amount in the conveying operation of the print medium A between the kth pass operation and the (k+1)th pass operation to be the second conveyance amount, and stores the second conveyance amount in the second memory 13b2 (step S41).

On the other hand, in a case where the second controller 13b determines that the information on the drying risk is “high” (step S23: NO, S26: NO), the second controller 13b obtains the second mask pattern Y as the mask to be applied to the image data of each of the kth overlap image B1a and the (k+1)th overlap image B1a which overlap with each other (step S29). Then, the second controller 13b obtains the partial image data of each of the kth partial image B1 and the (k+1)th partial image B1 in which the mask of the second mask pattern Y has been applied to these overlap images B1a, and stores the partial image data of each of the kth partial image B1 and the (k+1)th partial image B in the second memory 13b2 (step S30). Then, the second controller 13b determines the conveyance amount in the conveying operation of the print medium A between the kth pass operation and the (k+1)th pass operation to be the third conveyance amount, and stores the third conveyance amount in the second memory 13b2 (step S42).

Then, in the printing process of step S15 in FIG. 9, the second controller 13b obtains the partial image data of the kth partial image B1 from the second memory 13b2, executes the kth pass operation based on the partial image data, and forms the kth partial image B1 in the kth partial area A1. Then, the second controller 13b obtains the conveyance amount in the conveying operation between the kth pass operation and the (k+1)th pass operation from the second memory 13b2, and conveys the print medium A by this conveyance amount. Then, the second controller 13b obtains the partial image data of the (k+1)th partial image B1 from the second memory 13b2, executes the (k+1)th pass operation based on the partial image data, and forms the (k+1)th partial image B1 in the (k+1)th partial area A1. The (k+1)th overlap area A1a, which is located on the downstream of the (k+1)th partial area A1, and the kth overlap area A1a of the kth partial area A1 overlap each other. Accordingly, the (k+1)th overlap image B1a, which is located on the downstream of the (k+1)th partial image B1, and the kth overlap image B1a of the kth partial image B1 overlap each other.

In such a printing apparatus 10, the pass operation includes a first pass operation of ejecting the ink of the basic color from the first nozzles 22a while moving the first head 20a, and a second pass operation of ejecting the ink of the special color from the second nozzles 22b while moving the second head 20b. The conveyance amount in the conveying operation of the print medium A executed between the first pass operation currently performed (hereinafter referred also to as “current first pass operation” in some cases) and the first pass operation performed last time (hereinafter referred also to as “last first pass operation” in some cases) is the same as the conveyance amount in the conveying operation of the print medium A executed between the second pass operation currently performed (hereinafter referred also to as “current second pass operation” in some cases) and the second pass operation performed last time (hereinafter referred also to as “last second pass operation” in some cases).

That is, the second controller 13b converts the image data into image data of the basic color and image data of the special color in the color conversion process of step S11 in FIG. 9. Then, in the mask process of step S14, the second controller 13b applies the mask of the mask pattern, which is based on the information on the drying risk, to the overlap image B1a, of the partial image B1, as the object of each of the first pass operation based on the image data of the basic color and the second pass operation based on the image data of the special color. The information on the drying risk corresponds to the ejection frequency of the second nozzle 22b. For this reason, the masks of mutually the same mask patterns are applied to the image data of the basic color and the image data of the special color with respect to the kth overlap image B1a and the (k+1)th overlap image B1a which overlap each other.

In the printing process of step S15 in FIG. 9, the second controller 13b executes the current kth pass operation and the next (k+1)th pass operation as the first pass operation based on the image data of the basic color. The second controller 13b further executes the current kth pass operation and the next (k+1)th pass operation as the second pass operation based on the image data of the special color. The conveyance amount of the print medium A in the conveying operation between the kth pass operation and the (k+1)th pass operation corresponds to the size of the mask of the mask pattern applied to the kth overlap image B1a and the (k+1)th overlap image B1a which overlap with each other.

The mutually same mask patterns are applied to the kth overlap image B1a and the (k+1)th overlap image B1a based on the image data of the basic color and the kth overlap image B1a and the (k+1)th overlap image B1a based on the image data of the special color. Therefore, the conveyance amount of the print medium A in the conveying operation between the kth pass operation and the k+1th pass operation each of which is the first pass operation based on the image data of the basic color, and the conveyance amount of the print medium A in the conveying operation between the kth pass operation and the k+1th pass operation, each of which is the second pass operation based on the image data of the special color, are same as each other.

Note that mutually different mask patterns may be applied, respectively, to the overlap image B1a based on the image data of the basic color and the overlap image B1a based on the image data of the special color. For example, a mask pattern based on the ejection frequency of the ink of the basic color from the first nozzles 22a may be applied to the overlap image B1a based on the image data of the basic color. Further, a mask pattern based on the ejection frequency of the ink of the special color from the second nozzles 22b may be applied to the overlap image B1a based on the image data of the special color.

With this, a plurality of masks of mutually different mask patterns are applied, respectively, to the overlap image B1a based on the image data of the basic color and the overlap image B1a based on the image data of the special color, in some cases. Even in a case where the sizes of these mask patterns in the conveying direction are different, the second controller 13b may make the conveyance amount of the print medium A in the conveying operation between the kth pass operation and the (k+1)th pass operation each of which is the first pass operation based on the image data of the basic color same as the conveyance amount of the print medium A in the conveying operation between the kth pass operation and the (k+1)th pass operation each of which is the second pass operation based on the image data of the special color.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In all of the above-described embodiments and modifications, as depicted in FIG. 8A and FIG. 8B, the mask pattern of the mask applied to the kth overlap image B1a has the ratio line Lk in which the ratio Rk of the mask part decreases from the upstream end toward the downstream end in the conveying direction. Further, the mask pattern of the mask applied to the (k+1)th overlap image B1a has the ratio line Lk+1 in which the ratio Rk+1 of the mask part decreases from the downstream end toward the upstream end in the conveying direction. The ratio R of the mask part at an intersection position L of the ratio line Lk and the ratio line Lk+1 is equal between the first mask pattern and the second mask pattern X. Note that the ratio R of the mask part at the intersection position L of the ratio line Lk and the ratio line Lk+1 may be smaller in the second mask pattern X than in the first mask pattern.

In all of the above-described embodiments and modifications, the printing apparatus 10 is constructed of the first apparatus 10a and the second apparatus 10b disposed separately from each other. However, the printing apparatus 10 may be constructed of an apparatus in which the first apparatus 10a and the second apparatus 10b are integrally disposed.

In all of the above-described embodiments and modifications, the first head 20a, the second head 20b, and the third head 20c are mounted on the same carriage 11a and moved together by the moving device 11. However, the moving device 11 may include a first moving device configured to move the first head 20a, a second moving device configured to move the second head 20b, and a third moving device configured to move the third head 20c. The first head 20a, the second head 20b, and the third head 20c may be moved, respectively, by the first to third moving devices.

A plurality of masks of mutually different mask patterns may be applied, respectively, to the image data of the basic color of the first head 20a and the image data of the special color of the second head 20b. The sizes of the masks of these mask patterns in the conveying direction may be different from each other in some cases. In this case, the conveyance amount of the print medium A in the conveying operation between the kth pass operation and the (k+1)th pass operation may be determined according to the size in the conveying direction of the mask applied to the kth overlap image B1a and the (k+1)th overlap image B1a which overlap each other. As a result, the conveyance amount between pass operations based on the image data of the basic color of the first head 20a and the conveyance amount between pass operations based on the image data of the special color of the second head 20b may be different from each other.

In all of the above-described embodiments and modifications, the second apparatus 10b is the ink-jet printer of the serial head system. However, the present disclosure is not limited thereto. For example, the second apparatus 10b may be the ink-jet printer of a line-head system. In such a case, the second apparatus 10b executes, in the printing process, an ejecting operation of ejecting the ink from the plurality of nozzles, instead of the pass operation. Note that each of the pass operation and the ejection operation is an example of an “ejecting operation”.

It should be noted that all the above-described embodiments and modifications may be combined with each other as long as the embodiments and modifications do not exclude each other. Further, many improvements and other embodiments of the present disclosure will be apparent to those skilled in the art from the foregoing description. Therefore, the foregoing description should be construed as merely illustrative and being provided for the purpose of teaching those skilled in the art some modes for carrying out the present disclosure. The details of the structure and/or function of the present disclosure may be substantially changed without departing from the spirit of the present invention.

What is claimed is:

1. A printing apparatus comprising:
a head having a plurality of nozzles;
a conveyor configured to convey a print medium in a conveying direction; and
a controller, wherein:
the controller is configured to execute:
a first obtaining process of obtaining information on drying risk of an ink in the plurality of nozzles; and
a printing process of performing an ejecting operation of ejecting the ink from the plurality of nozzles to the print medium based on image data of a partial image being a part of a print image, and a conveying operation of conveying the print medium;
the partial image includes:
an overlap image being an area to be overlapped with another partial image adjacent to the partial image; and
a non-overlap image being an area different from the overlap image and not to be overlapped with the another partial image;
the controller is configured to, in the printing process, overlap the overlap image of the partial image as an object of the ejecting operation performed currently with the overlap image of the partial image as an object of the ejecting operation performed last time;
the controller is further configured to execute a second obtaining process of obtaining, based on the information on the drying risk, a first mask pattern or a second mask pattern as a mask pattern of a mask to be applied to image data of the overlap image, the mask pattern including a mask part configured to cause the ink not to be ejected from a nozzle, of the plurality of nozzles, corresponding to the overlap image in the ejecting operation; and
a number of the mask part of the second mask pattern with respect to an end part, of the overlap image, located away from the non-overlap image in the conveying direction is smaller than a number of the mask part of the first mask pattern with respect to the end part, of the overlap image, located away from the non-overlap image in the conveying direction.

2. The printing apparatus according to claim 1, wherein the information on the drying risk is based on ejection frequency of the ink from the plurality of nozzles in the ejecting operation performed up to the ejecting operation performed last time.

3. The printing apparatus according to claim 1, wherein:
the plurality of nozzles includes:
a first nozzle configured to eject an ink of a basic color; and
a second nozzle configured to eject an ink of a special color different from the basic color; and
the information on the drying risk is based on the ejection frequency of the ink of the special color from the second nozzle.

4. The printing apparatus according to claim 1, wherein:
the mask of the second mask pattern has a size in the conveying direction smaller than a size in the conveying direction of the mask of the first mask pattern; and
a conveyance amount of the print medium in the conveying operation executed between the ejecting operation performed currently and the ejecting operation to be performed next is greater in a case where the mask of the second mask pattern is applied to the image data of each of the overlap image as the object of the ejecting operation performed currently and the overlap image as an object of the ejecting operation to be performed next so as to overlap with the overlap image as the object of the ejecting operation performed currently, than in a case where the mask of the first mask pattern is applied to the image data of each of the overlap image as the object of the ejecting operation performed currently and the overlap image as the object of the ejecting operation to be performed next.

5. The printing apparatus according to claim 4, wherein:
the head includes:
a first head including a first nozzle configured to eject an ink of a basic color; and
a second head disposed to be shifted with respect to the first head in the conveying direction and including a second nozzle configured to eject an ink of a special color different from the basic color;
the ejecting operation includes:
a first ejecting operation of ejecting the ink of the basic color from the first nozzle; and
a second ejecting operation of ejecting the ink of the special color from the second nozzle; and
a conveyance amount of the print medium in the conveying operation executed between the first ejecting operation performed currently and the first ejecting operation performed last time is same as a conveyance amount of the print medium in the conveying operation executed between the second ejecting operation performed currently and the second ejecting operation performed last time.

6. The printing apparatus according to claim 1, wherein:
in the mask pattern to be applied to the image data of the overlap image in the ejecting operation, a ratio of the mask part to the overlap image increases further at a location in the overlap image farther away from the non-overlap image along the conveying direction; and
a change rate of the ratio of the mask part along the conveying direction is larger in the first mask pattern than in the second mask pattern.

7. The printing apparatus according to claim 1, wherein:
the first mask pattern includes a pattern of a changing type, a ratio of the mask part changing along the conveying direction in the changing type; and
the second mask pattern includes a pattern of the changing type and/or a pattern of a constant type, the ratio of the mask part being constant along the conveying direction in the constant type.

8. The printing apparatus according to claim 1 further comprising a carriage configured to move the head in a moving direction crossing the conveying direction,
wherein the controller is configured to perform a pass operation of ejecting the ink while moving the head as the ejecting operation.

9. A control method of a printing apparatus, the printing apparatus including:
a head having a plurality of nozzles; and
a conveyor configured to convey a print medium in a conveying direction,
the control method comprising causing the printing apparatus to execute:
a first obtaining process of obtaining information on drying risk of an ink in the plurality of nozzles; and
a printing process of performing an ejecting operation of ejecting the ink from the plurality of nozzles to the print medium based on image data of a partial image being a part of a print image, and a conveying operation of conveying the print medium, wherein:
the partial image includes:
an overlap image being an area to be overlapped with another partial image adjacent to the partial image; and
a non-overlap image being an area different from the overlap image and not to be overlapped with the another partial image; and
in the printing process, the overlap image of the partial image as an object of the ejecting operation performed currently is overlapped with the overlap image of the partial image as an object of the ejecting operation performed last time,
the control method further comprising causing the printing apparatus to execute a second obtaining process of obtaining, based on the information on the drying risk, a first mask pattern or a second mask pattern as a mask pattern of a mask to be applied to image data of the overlap image, the mask pattern including a mask part configured to cause the ink not to be ejected from a nozzle, of the plurality of nozzles, corresponding to the overlap image in the ejecting operation,
wherein a number of the mask part of the second mask pattern with respect to an end part, of the overlap image, located away from the non-overlap image in the conveying direction is smaller than a number of the mask part of the first mask pattern with respect to the end part, of the overlap image, located away from the non-overlap image in the conveying direction.

10. A non-transitory and computer-readable medium storing a program executable by a controller of a printing apparatus, the printing apparatus including:
a head having a plurality of nozzles;
a conveyor configured to convey a print medium in a conveying direction; and
the controller,
the program is configured to cause the controller to execute:
a first obtaining process of obtaining information on drying risk of an ink in the plurality of nozzles; and
a printing process of performing an ejecting operation of ejecting the ink from the plurality of nozzles to the print medium based on image data of a partial image being a part of a print image, and a conveying operation of conveying the print medium, wherein:
the partial image includes:
an overlap image being an area to be overlapped with another partial image adjacent to the partial image; and
a non-overlap image being an area different from the overlap image and not to be overlapped with the another partial image; and
in the printing process, the overlap image of the partial image as an object of the ejecting operation performed currently is overlapped with the overlap image of the partial image as an object of the ejecting operation performed last time,
the program is further configured to cause controller to execute a second obtaining process of obtaining, based on the information on the drying risk, a first mask or a second mask as a mask pattern of a mask to be applied to image data of the overlap image, the mask pattern including a mask part configured to cause the ink not to be ejected from a nozzle, of the plurality of nozzles, corresponding to the overlap image in the ejecting operation,
wherein a number of the mask part of the second mask pattern with respect to an end part, of the overlap image, located away from the non-overlap image in the conveying direction is smaller than a number of the mask part of the first mask pattern with respect to the end part, of the overlap image, located away from the non-overlap image in the conveying direction.
